(19) United States
(12) Patent Application Publication
(10) Pub. No.: US 2005/0125788 A1
(43) Pub. Date: Jun. 9, 2005

(54) Wizard-based installation package with run-time debugging support

(75) Inventors: Francesco Lupini, Roma (IT); Luigi Pichetti, Rome (IT); Antonio Secomandi, Brugherio Milano (IT)

Correspondence Address: Jeffrey S. LaBaw;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/892,434

(22) Filed: Jul. 15, 2004

(30) Foreign Application Priority Data
Dec. 3, 2003 (EP) 03368108.1

(51) Int. Cl. G06F 9/445; G06F 9/44

(52) U.S. Cl. 717/174; 717/168; 717/124

(57) ABSTRACT

A method (300) of installing software applications using a wizard-based installation package (for example, built using “InstallShield”) is proposed. The installation package is defined declaring a discoverer Bean (308), a producer Bean (312), a consumer Bean (314) and a debugger Bean (315) into the wizard tree (while the product tree is left empty). During the installation process, the discoverer creates (322-346) a working queue dynamically, inserting the installation operations that are needed for reaching a desired configuration (defined in a descriptor of the software application) from a current configuration (detected at run-time). The consumer executes (348-362) the installation operations defined in the working queue in succession. Whenever an error condition is detected (352, 356, 360), the installation process is suspended (368) and the debugger is invoked (372). An administrator can browse (378) an execution log of each installation operation and update (380-383) any wrong operative parameter. The installation process is then resumed (375) without having to repeat the installation operations already executed.

### TECHNICAL FIELD

The present invention relates to the data processing field, and more specifically to a software installation method and a corresponding structure for use in a data processing system.

### BACKGROUND ART

The installation of software applications plays a key role in the management of complex data processing systems. For example, this is a very time consuming activity in large organizations embracing thousands of computers, wherein the configurations of the computers are periodically updated in order to be abreast of the information technology development or to comply with organizational changes; typically, the update of the configuration of each computer involves installing and disinstalling software products or upgrading the software products already available to new versions thereof. In the following, the above-described activities will be generically referred to as installation process; however, it should be understood that the term installation as used hereinafter refers to any activities causing the enforcement (i.e., the addition, the updating or the removal) of software features, unless otherwise specified.

The installation of each software product requires the building of a corresponding package. Several installation authoring tools have been proposed in the last years to assist a software developer to create professional looking, reliable and flexible installation packages. All the authoring tools known in the art (such as “InstallShield”, described in Learning Multi-Platform Edition Training Manual, Robert M. Dickau—TRNMPLM01-1602) are based on a declarative wizard model. In a wizard-based tool, the developer is required to declare any installation element to be embedded into the package (for use during the installation process). Typically, a product tree is used to declare functions implementing the installation of each feature of the software product; a wizard tree is used to declare panels for controlling the interaction with an end-user. When the end-user runs the installation package, the panels declared in the wizard tree are displayed in the desired sequence; typically, those panels are used to select the features to be added or removed, and to enter operative parameters controlling the installation process (for example, defining a destination of the software product). The selected features are then installed on the computer according to the corresponding operative parameters.

However, in the authoring tools known in the art the end-user cannot interact with the installation process once the enforcement of the selected features has started.

Particularly, this drawback is perceived whenever an error condition occurs during the installation process. Indeed, if the error is severe the installation of the whole software product is aborted; conversely, a warning is provided to the end-user and the installation process continues.

In any case, the end-user has to analyze a summary message logged at the end of the installation process to ascertain the nature of the error. Moreover, this summary message is often difficult to read (being either too complex or non-focused on the specific error).

Therefore, even when the error can be fixed the whole installation process is always to be repeated; for example, a commonplace case is that of an error caused by a wrong operative parameter that has been entered by the end-user at run-time (which operative parameter could not be validated in advance).

An additional drawback is due to the impossibility of updating any operative parameter that is hard-coded in the installation package (for example, an operative parameter that is incompatible with a specific software and/or hardware configuration of the computer).

The above-described behavior is unacceptable when dealing with the installation of complex software applications, which require the execution of a high number of installation operations on different computers.

### SUMMARY OF THE INVENTION

It is an object of the present invention to provide a wizard-based installation package, which allows interacting with the enforcement of the desired software features.

Particularly, it is an object of the present invention to allow interacting with the installation package whenever an error condition occurs.

It is another object of the present invention to facilitate the debugging to the installation package.

It is yet another object of the present invention to avoid repeating the whole installation process once the error has been fixed.

Particularly, it is an object of the present invention to allow correcting wrong operative parameters dynamically.

The accomplishment of these and other related objects is achieved by a software installation method using a wizard-based installation package for enforcing desired software features on a data processing system according to a set of operative parameters, the method including the steps of: installing the package on the system, suspending the installation in response to an error condition relating to at least one operative parameter of the set, updating the at least one operative parameter, and resuming the installation.

The present invention also provides a computer program for performing the method and a program product embodying the program; a corresponding software installation structure is also encompassed.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1 is a schematic block diagram of a data processing environment in which the method of the invention is applicable;

FIG. 2 depicts the main software components used for implementing the method;

FIGS. 3a-3d show a diagram describing the flow of activities relating to an installation process;

FIG. 4 illustrates an implementation of consumable objects used during the installation process; and

FIGS. 5a-5f depict the various phases of an exemplary installation process.

### DETAILED DESCRIPTION OF THE PREFERRED EMBODIMENT(S)

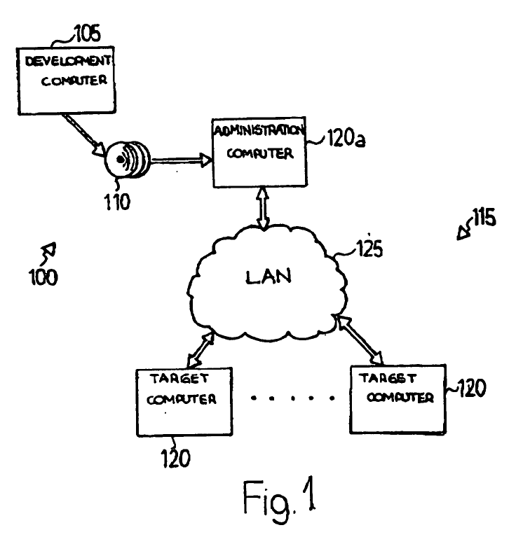

With reference in particular to FIG. 1, a data processing environment 100 wherein the invention can be practiced is shown. The data processing environment 100 includes a development computer 105, which is used to build packages (or release images) for installing software products. The installation packages are duplicated on CD-ROMs 110; the CD-ROMs 110 are then transmitted to different data processing systems 115 (only one shown in the figure).

The data processing system 115 has a distributed architecture, wherein multiple target computers 120 communicate through a network 125 (for example, a LAN). One of the target computers (differentiated by adding the suffix “a”, that is 120a) operates as an administration computer. The administration computer 120a directly receives the CD-ROMs 110 (from the development computer 105); the installation package stored on the CD-ROMs 110 is then run, in order to install the corresponding software products (or portions thereof) on selected target computers 120.

Similar considerations apply if the method is used in an equivalent environment, or if the software products are installed on different data processing systems (for example, INTERNET-based). However, the concepts of the present invention are also applicable when the software products are installed on stand-alone computers.

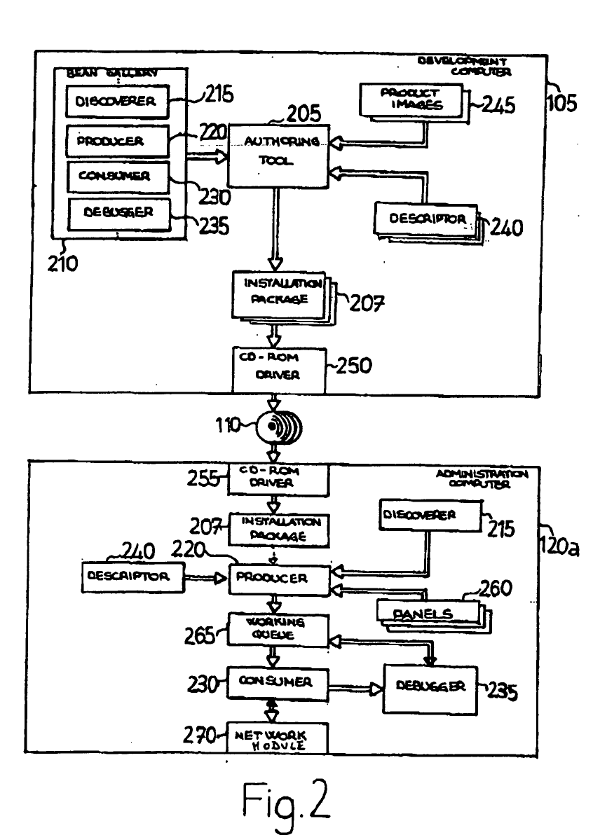

The main software components that are used to implement the proposed solution are illustrated in FIG. 2. A developer working on the computer 105 uses an installation authoring tool 205, which is based on a declarative wizard model (such as “InstallShield”). The authoring tool 205 provides a graphical interface that helps the developer to create installation packages 207. For each software product to be deployed, the developer defines a project; the project is structured as a collection of basic elements implemented with Java Beans (or simply Beans). The Beans are reusable software components that comply with a pre-set specification, consisting of a series of common rules and principles that define standard naming conventions and type signatures. All the Beans that are available to the authoring tool 205 (i.e., standard Beans shipped with the authoring tool 205 and custom Beans defined by the developer) are registered with a gallery 210.

The authoring tool supports the definition of a product tree and a wizard tree. The product tree can be used to organize corresponding Beans, which describe a layout of the software product. The product tree is structured in a hierarchy with three levels. The software product defines a root of the product tree. The software product contains one or more features, which are the smallest elements that are visible during an installation process of the software product. Each feature consists of one or more components (being not visible during the installation process); the components directly contain the data to be used and define the operations to be performed during the installation process. For example, the components specify files to be added or removed, instructions for creating desktop icons, modifying environmental variables, writing or deleting information in text files, running specific command lines, and the like.

The developer controls whether each product Bean is active during the installation process by attaching one or more conditions (such as platform-based conditions). Moreover, the developer specifies different properties for the product Bean; for example, it is possible to define a default condition of the product Bean (active or inactive), a target location for the installation, the desired behavior when information must be replaced or removed, other components or features required by the product Bean, and the like.

The wizard tree can be used to organize corresponding Beans, which implement Graphical User Interface (GUI) utilities for helping install the software product. The wizard Beans are placed under a root of the tree, and specify the ordering of panels to be displayed or actions to be performed during the installation process. For example, the authoring tool supports wizard Beans providing a number of commonplace panels (implementing welcome, destination, setup type, features selection, preview, license approval, password, and summary functions). On the other hand, the wizard Beans for the actions make it possible to specify the installation or the disinstallation of the software product, the setting of product Bean properties, the jumping to a desired wizard Bean, the embedding of specific files into the installation package, and the like. The wizard Beans can also be collected into sequences; a sequence contains other wizard Beans, which are conditionally executed or skipped as a whole.

The developer controls whether each wizard Bean is active during the installation process by attaching one or more conditions (similar to the ones of the product Beans). In addition, the developer specifies different properties for the wizard Bean; for example, it is possible to define the format of the corresponding panel, a text to be displayed, the navigation buttons available (for example, back, next and cancel), and the like.

Moreover, the authoring tool allows setting different properties of the installation package to be built. For example, the developer can define the type of archive to be built (such as a collection of CD-ROMs), one or more setup launchers for running the installation package on different software platforms, whether the installation package will be distributed as a single self-extracting archive (embedded in the setup launcher), and the like. Typically, the authoring tool also supports an automated build process that can be invoked from a command line or a script.

In a typical scenario according to the prior art, the authoring tool 205 is used for installing a simple software product on a single computer. In this case, all the features of the software product (each one consisting of one or more components) are defined in the product tree; the sequence of panels and actions for installing the software product is defined in the wizard tree. When an end-user applies the corresponding installation package, he/she is provided with a series of panels as defined in the wizard tree (typically, for choosing the destination of the software product and the features to be added or removed). For each feature to be installed, the corresponding product Beans are enabled (setting their properties to active); conversely, the other product Beans are disabled. The wizard tree then includes a Bean triggering the installation of the software product; as a consequence, the operations defined by the (active) Beans included in the product tree are performed. If any error occurs, the whole installation process is aborted; the setup launcher then creates a log file and displays a corresponding panel.

Conversely, in the preferred embodiment of the present invention (as described in detail in the following) the same authoring tool 205 is used to build installation packages 207 that exhibit a dynamic behavior. For this purpose, a set of specific custom Beans are registered with the gallery 210. Particularly, the Bean gallery 210 includes a custom Bean 215 acting as a discoverer, a custom Bean 220 acting as a producer, a custom Bean 230 acting as a consumer, and a custom Bean 235 acting as a debugger. Moreover, the authoring tool 205 accesses descriptors 240, each one defining a solution to be deployed using the authoring tool 205 (for example, consisting of a complex distributed software application based on multiple products).

Once the definition of the project has been completed, the developer builds the corresponding installation package 207. The installation package 207 embeds the discoverer 215, the producer 220, the consumer 230, and the debugger 235; moreover, the installation package embeds the descriptor 240 of the desired software application. The installation package 207 can also include images of the software products to be installed, which product images are retrieved from a corresponding repository 245; alternatively, the product images are simply identified by links to depots from which they can be downloaded.

The installation package 207 is provided to a CD-ROM driver 250, which controls the duplication of the installation package 207 on the CD-ROMs 110. The CD-ROMs 110 are then distributed to the administration computer 120a. A CD-ROM driver 255 running on the administration computer 120a reads the installation package 207 from the CD-ROMs 110. An administrator working on the computer 120a applies the installation package 207 by running the corresponding setup launcher. The installation package 207 can also be applied in a console mode (for computers that do not have any graphical interface) or in a silent mode (without displaying any panel, and using default values and values read from a response file).

The resulting installation process involves the loading of different software components. In detail, the discoverer 215 detects a current configuration of the data processing system managed by the administration computer 120a. The current configuration includes information about a topology of the data processing system (identifying the target computers and their arrangement); for each target computer, the current configuration also specifies all the products that are already installed. Moreover, the discoverer 215 identifies one or more roles that are played by each target computer; the roles can be either architectural roles that have been assigned to the target computers during their configuration (for example, a database server) or logic roles that are inferred from the installed products (for example, a performance monitor server).

The current configuration of the system is provided to the producer 220. The producer 220 accesses the descriptor 240 of the software application to be installed. For each role, the descriptor 240 specifies a desired configuration of the target computers playing that role and the operations required to reach the desired configuration (from their current configuration). The installation process is further controlled by one or more operative parameters; the operative parameters may be either predefined in the installation package or entered at run-time by the administrator using a series of panels 260.

Accordingly, the producer 220 creates a working queue 265, which specifies the operations to be performed for installing the software application. The consumer 230 in succession executes the installation operations specified in the working queue 265; for this purpose, the consumer 230 interfaces with a network module 270 (controlling the communications with the other target computers). As described in detail in the following, whenever an error condition is detected the consumer 230 invokes the debugger 235. The debugger 235 interfaces with the working queue 265 for controlling the installation process interactively.

Similar considerations apply if the programs and the corresponding data are structured in another way, or if the installation packages are provided on an equivalent computer readable medium (such as a DVD). Moreover, the concepts of the present invention are also applicable when the installation packages have a different structure, when equivalent installation elements are embedded, or when the software applications are defined in a different way (even without the specification of any roles of the target computers). Alternatively, the installation packages are defined and built in another way, for example, using equivalent authoring tools (such as “InstallAnywhere”, “Wise Installation System” or “Setup Builder”).

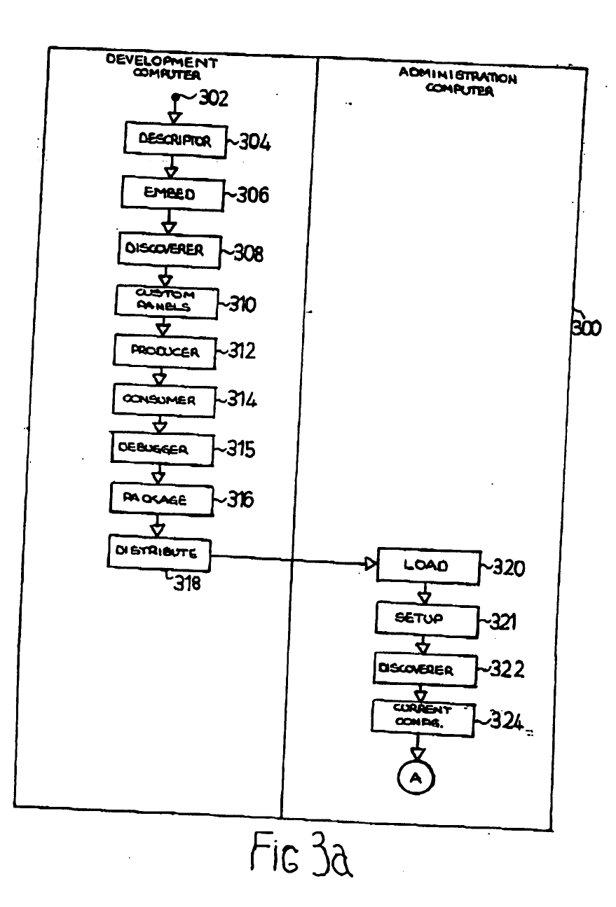

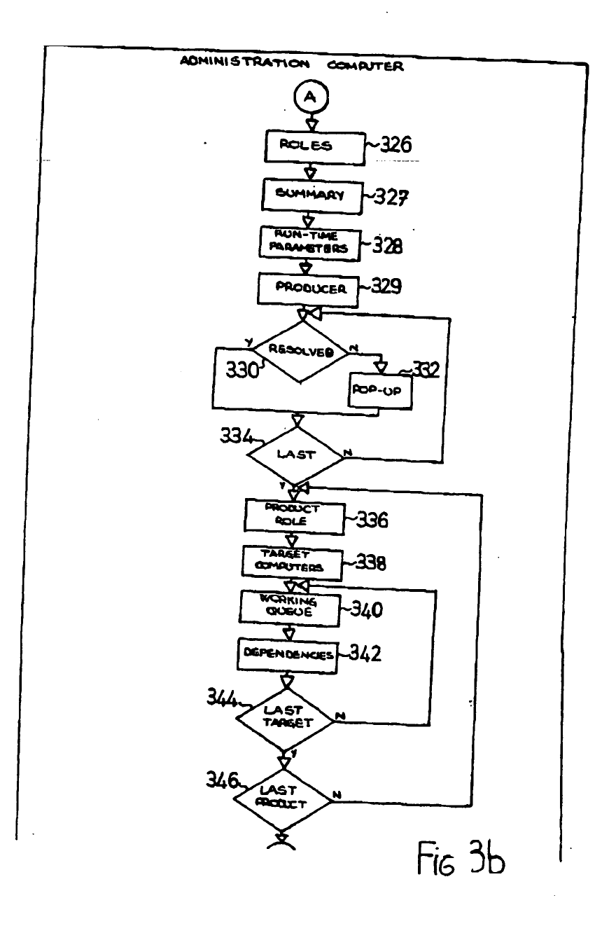

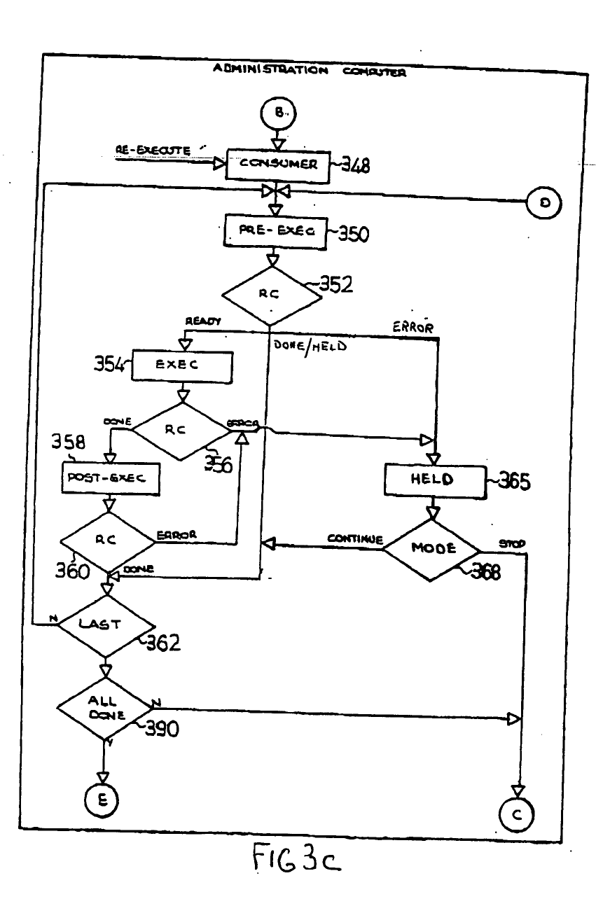

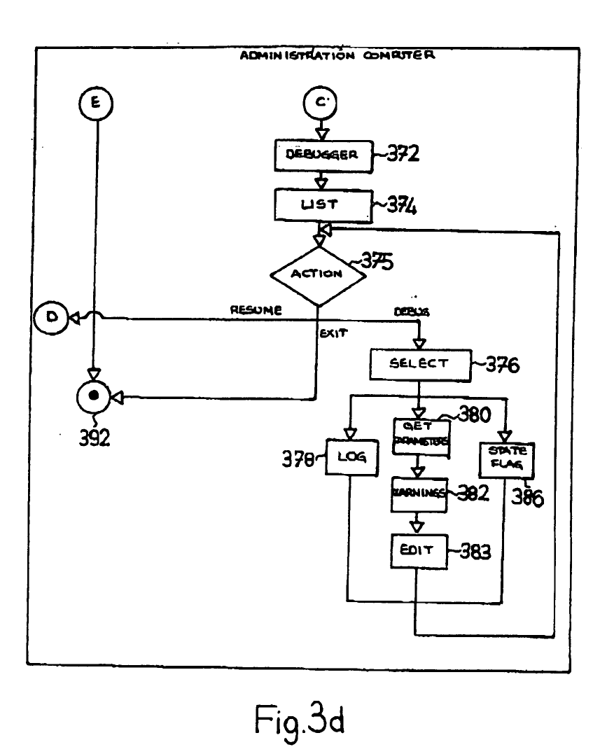

Considering now FIGS. 3a-3d, a method 300 performed during the installation process is illustrated. The method 300 begins at the black start circle 302 in the swim-lane of the development computer. Continuing to block 304, the software application is defined in the corresponding descriptor. Descending into block 306, the developer starts the authoring tool and inserts a Bean into the wizard tree for embedding the descriptor (and possibly the required product images). The method then passes to block 308, wherein the developer inserts the discoverer into the wizard tree as well; typically, the discoverer is placed after some standard wizard Beans (for example, defining welcome and password panels). If the software application requires complex run-time parameters to be entered during the installation process, the developer at block 304 inserts one or more additional Beans into the wizard tree (for displaying corresponding custom panels). Considering now block 312, the producer is likewise inserted into the wizard tree. The developer then inserts the consumer into the wizard tree at block 314, typically after some further standard wizard Beans (for example, defining license approval and preview panels). At the end, the debugger is inserted into the wizard tree at block 315.

The flow of activity continues to block 316 as soon as the definition of the wizard tree has been completed (while the product tree is left empty); the corresponding installation package is then built embedding all the elements declared in the wizard tree. Passing to block 318, the installation package is recorded on CD-ROMs and distributed to the administration computer.

Moving now to the swim-lane of the administration computer, the installation package is received and loaded at block 320. The setup launcher associated with the installation package is then run by the administrator at block 321. In response thereto, the discoverer is invoked at block 322 (after displaying the panels corresponding to the preceding Beans in the wizard tree). The discoverer at block 324 detects the current configuration of the system managed by the administration computer (i.e., its topology and the products installed on each target computer). Continuing to block 326, the detected information is used to identify the role(s) of each target computer. The process then passes to block 327, wherein a summary of the current configuration of the system is displayed in a corresponding panel. The administrator is allowed to update the configuration of the system (for example, changing the roles of one or more target computers); once the administrator accepts the proposed configuration, the process descends into block 328.

Considering now block 328, the Beans (if any) included in the wizard Beans for entering complex run-time parameters are invoked. As a consequence, the corresponding custom panels are displayed, prompting the administrator to enter the values of the run-time parameters needed for the installation process; those run-time parameters are stored in a global memory space. Descending into block 329, the producer is now invoked. For each run-time parameter defined in the descriptor (starting from the first one), the producer verifies at block 330 whether the run-time parameter has already been resolved (i.e., whether its value has been entered by the administrator at block 328). If not, a pop-up window is automatically displayed at block 332, prompting the administrator to enter the value of the run-time parameter; the process then passes to block 334. Conversely, the flow of activity descends into block 334 directly. A test is then made at block 334 to verify whether the last run-time parameter has been processed. If not, the method returns to block 330 for repeating the operations described above on a next run-time parameter; conversely, the flow of activity descends into block 336.

With reference now to block 336, for each software product of the application (starting from the first one), the producer extracts the associated role (or roles) from the descriptor. The target computers playing that role are identified at block 338. The producer at block 340 inserts one or more items into the working queue for the first target computer on which the software product must be installed, which items specify the installation operations required to bring the target computer to the desired configuration defined in the descriptor (starting from its current configuration). Proceeding to block 342, the producer identifies all the installation operations that are prerequisite to the execution of the current ones (as indicated in the descriptor); those installation operations are updated to include a pointer to the installation operations dependent thereon. At the same time, the producer analyses the operative parameters of the installation operations (i.e., predefined parameters and run-time parameters); whenever an operative parameter is already referenced by a previous installation operation, a corresponding warning flag is set. A test is then made at block 344 to determine whether the last target computer (wherein the software product must be installed) has been processed. If not, the method returns to block 340 for repeating the operations described above on a next target computer. Conversely, the flow of activity enters decision block 346, wherein the producer verifies whether the last software product of the application has been processed. If not, the method returns to block 336 for repeating the operations described above on a next software product (as defined in the descriptor). On the contrary, the method exits the above-described loop and descends into block 348; the same block is also reached directly whenever the installation process is re-executed (having being interrupted after the creation of the working queue).

Considering now block 348, the consumer is likewise invoked. The consumer at block 350 performs a pre-execution verification of each installation operation (starting from the first one according to the sequence specified in the working queue). In this phase, the method verifies whether the installation operation can be executed and sets a state flag accordingly (which state flag is returned to the consumer as a code indicative of the pre-execution verification result). The flow of activity then branches at decision block 352 according to the value of the state flag. Particularly, the state flag has a value READY when the installation operation is still to be executed and the required resources are all available; in response thereto, the installation operation is actually executed at block 354 (setting the respective state flag according to the execution result). A test is made at block 356 on the state flag returned by the execution of the installation operation. Assuming that the state flag has a value DONE (indicative of a successful execution), the method continues to block 358. The consumer now performs a post-execution processing of the installation operation (and sets the state flag accordingly). Typically, in this phase the consumer deletes any temporary file created during the execution, or verifies whether the target computer on which the installation operation has been executed is in the desired condition (for example, whether any data structure that should have been added actually exists); at the same time, a log relating to the execution of the installation operation is saved into a corresponding repository. If the state flag retains the value DONE (i.e., no exception has been detected), the method descends into decision block 362. A test is then made to determine whether the last installation operation in the working queue has been processed; if not, the method returns to block 350 for repeating the operations described above on a next installation operation.

Referring back to block 352, the state flag returned by the pre-execution verification has the value DONE when the installation operation has already been executed (either during a previous application of the installation package or by another process); on the other hand, the state flag has a value HELD when the execution of the installation operation has been deferred (as described in the following). In both cases, the installation operation is skipped and the method descends into block 362 directly.

Conversely, the state flag returned by the pre-execution verification at block 352 has a value ERROR to indicate that the installation operation cannot be executed (for example, because some required resources are not available). In response thereto, the flow of activity continues to decision block 365. The same point is also reached from block 356 when the execution of the installation operation has been unsuccessful or from block 360 when an exception has been detected by its post-execution processing (and the state flag has been set to the value ERROR accordingly).

Considering now block 365, the state flags of all the installation operations dependent from the current one are set to the value HELD (so that their execution will be skipped). The flow of activity then branches at block 368 according to the mode of operation of the consumer. If the consumer has been configured to force the installation process to continue, the method descends into block 362 for processing a next installation operation. Conversely, if the consumer has been configured to stop the installation process, the blocks 372-386 are executed (as described in the following). Referring back to block 362, once all the installation operations in the working queue have been processed the method descends into block 390. A test is then made to determine whether the installation process has been successfully completed (i.e., whether the state flags of the installation operations are all at the value DONE). If not, the blocks 372-386 are likewise executed; conversely, the flow of activity ends at the concentric white/black stop circles 392.

Considering now block 372, the installation process is suspended and the debugger is invoked. A list of all the installation operations with their state flags is displayed at block 374. Proceeding to decision block 375, the actions corresponding to a command entered by the administrator are performed. Particularly, if the administrator decides to debug the installation package a specific installation operation is selected at block 376. The flow of activity then branches according to the different options available. Particularly, the administrator at block 378 can display and analyze the execution log of the (selected) installation operation, in order to identify the cause of the error. For example, the error can be due to an environmental problem (such as the temporary unavailability of a network connection) or to a wrong operative parameter (either entered at run-time or hard-coded in the installation package). In the case of an environmental problem, the administrator can try to solve the problem or work around it (for example, restoring the network connection). On the other hand, the administrator can edit the operative parameters of the installation operation at blocks 380-383. Considering in particular block 380, the debugger retrieves the operative parameters (from the global memory space). The operative parameters referenced by other installation operations (warning flags asserted) that have already been executed (state flags at the value DONE) are identified at block 382; those operative parameters are highlighted so as to inform the administrator that their change can cause inconsistencies. The administrator is then allowed to update any desired operative parameter of the installation operation at block 383 (with the changes that are reflected into the working queue automatically). Once the debugging of the installation operation has been concluded, the administrator can change the corresponding state flag at block 386 (for example, from the values ERROR or HELD to the value READY). In any case, the flow of activity then returns to block 375 waiting from a next command of the administrator.

Referring to block 375 again, when the administrator decides to resume the installation process the method returns to block 350 (so as to process all the installation operations having the state flag still at the value READY). Conversely, if the installation process is aborted the flow of activity ends at the stop circles 392.

Similar considerations apply if an equivalent method is performed, or if the debugger supports different options (for example, allowing the execution of a single installation operation or without any warning for the operative parameters that have already been used). Alternatively, the state flags are replaced with equivalent indicators, or the installation operations are executed in another way (for example, without any post-execution processing). Moreover, the installation package can support a different number of operative parameters (down to a single one), or only specific operative parameters can be updated dynamically (such as the run-time parameters). In any case, the concepts of the present invention are also applicable when the wizard tree includes a different number of custom Beans (down to a single one that invokes the discoverer, the producer and the consumer in succession, with the debugger that is invoked by the consumer in turn).

Preferably, the descriptor is specified in the Extensible Markup Language (XML), which allows the creation of customized tags for any desired purpose. A section is defined for each software product of the application; the product section starts with a tag <Product> and ends with a tag </Product>. The product section includes a description of the product between the tags <Descr> and </Descr>. An identification tag of the product is enclosed between the tags <ProductID> and </ProductID>. The identification tag of different products implying the installation of that product (referred to as manifest tags) are enclosed between the tags <ManifestID> and </ManifestID>. For example, the product section of an old version of a product includes the more recent versions thereof as manifest tags; likewise, the product section of a component in a software suite includes that suite as manifest tag. Any product that is required as a prerequisite is specified between the tags <DependID> and </DependID>. Moreover, the name of the corresponding product image is indicated between the tags <Image> and </Image>. The product section further includes a portion that starts with a tag <Roles> and ends with a tag </Roles>. Each role requiring the installation of the product is indicated between the tags <TargetRole> and </TargetRole>.

The operative parameters used for the installation of the product are defined between the tags <Parameter> and </Parameter>. Each operative parameter consists of a key/value pair; the key of the parameter is defined between the tags <ParameterKey> and </ParameterKey>, whereas the name of a global variable wherein its value is stored is defined between the tags <ParameterVar> and </ParameterVar> (with the global variable that can be set to a default value). The name of a class that is responsible to install the product is defined in a portion that starts with a tag <Class> and ends with a tag </Class>. The name of the installation class is indicated between the tags <ClassID> and </ClassID>; any argument to be passed to the installation class is provided between the tags <ClassArg> and </ClassArg>. The consumer is also provided with a default installation class, which is used to install the product when no specific installation class is defined in the corresponding section.

For example, the following XML code:

```
<Product>
    <Descr>MyDescrA</Descr>
    <ProductID>MyProductA</ProductID>
    <Image>MyImageA</Image>
    <Roles>
        <TargetRole>MyRole</TargetRole>
    </Roles>
    <Parameter>
        <ParameterKey>MyKeyA</ParameterKey>
        <ParameterVar>MyVarA</ParameterVar>
    </Parameter>
    <Class>
        <ClassID>MyClassA</ClassID>
        <ClassArg>MyArgA</ClassArg>
    </Class>
</Product>
<Product>
    <Descr>MyDescrB</Descr>
    <ProductID>MyProductB</ProductID>
    <Image>MyImageB</Image>
    <Roles>
        <TargetRole>MyRole</TargetRole>
    </Roles>
    <DependID>MyProductA</DependID>
    <Parameter>
        <ParameterKey>MyKeyA</ParameterKey>
        <ParameterVar>MyVarA</ParameterVar>
    </Parameter>
    <Parameter>
        <ParameterKey>MyKeyB</ParameterKey>
        <ParameterVar>MyVarB</ParameterVar>
    </Parameter>
    <Class>
        <ClassID>MyClassB</ClassID>
        <ClassArg>MyArgB</ClassArg>
    </Class>
</Product>
```

defines two different products to be installed on the same target computers.

Particularly, a product “MyProductA” is described by the string “MyDescrA”. The installation of the product “MyProductA” does not require any prerequisite. The corresponding product image is stored in the file “MyImageA”. The product “MyProductA” must be installed on the target computers playing the role “MyRole”. The parameter consisting of the key/value pair “MyKeyA”/“MyVarA” is used for the installation of the product “MyProductA” (with the value of the parameter “MyKeyA” that is stored in the global variable “MyVarA”). The installation class “MyClassA” (receiving the argument “MyArgA”) is responsible to install the product “MyProductA”. Moreover, a further product “MyProductB” is described by the string “MyDescrB”. The installation of the product “MyProductB” requires the installation of the product “MyProductA” as a prerequisite. The corresponding product image is stored in the file “MyImageB”. The product “MyProductB” must be installed on the same target computers playing the role “MyRole”. The parameters consisting of the key/value pairs “MyKeyA”/“MyVarA” and “MyKeyB”/“MyVarB” are used for the installation of the product “MyProductB”. The installation class “MyClassB” (receiving the argument “MyArgB”) is responsible to install the product “MyProductB”.

In this case, during the installation process the warning flag associated with the operative parameter “MyKeyA” for the product “MyProductB” will be asserted (to inform the administrator that the same operative parameter is already used for the installation of the product “MyProductA”). Moreover, should any error occur during the installation of the product “MyProductA”, the state flag associated with the product “MyProductB” is set to the value HELD.

During the installation process, as shown in FIG. 4, each instance of the different installation classes defines a consumable object 405, which is inserted into the working queue 265. The consumable object 405 implements a consumable interface 410, which defines the behavior of the consumable object 405 during the installation process. Particularly, three methods:
public int preConsume(WizardServices myWizardServices)
public int doConsume(WizardServices myWizardServices)
public int postConsume(WizardServices myWizardServices)
   are used to implement the pre-execution verification, the actual execution and the post-execution processing, respectively, of the installation operation associated with the consumable object 405. Each method receives an object myWizardServices of the type WizardServices (providing a collection of operations available to the consumable object 405 to perform at run-time) and returns an integer representing the resulting state flag. A further method:
public ResultRecord getLog( )
   returns a container holding the execution log of the consumable object 405. Moreover, a getter method and a setter method (according to the Java Beans standard):
public Properties getParameters( )
public void setParameters (Properties myProperties)
   are used to read and to write, respectively, the operative parameters of the consumable object 405.

Whenever the consumer extracts a generic consumable object 405 from the working queue 265, the consumable object 405 is processed calling the methods preConsume, doConsume and postConsume in succession. The method preConsume creates a corresponding executable object 415. A corresponding method is then called on the executable object 415 for creating one or more objects 420, each one for a corresponding installation operation. Each action object 420 implements an executable interface 425, which defines the basic functions required for controlling the processing of the installation operation. In this way, any pre-existing classes providing installation operations can be reused in the proposed solution simply adding a portion of glue code that makes those classes compliant with the executable interface 425.

Similar considerations apply if the descriptor supports different tags, or if the consumable interface exposes additional methods (for example, for getting and setting protected operative parameters not to be shown in clear, for estimating a length of the corresponding installation operation, and the like). However, the concepts of the present invention are also applicable when the descriptor is defined in another way (even using a different language), or when the installation operations are implemented with equivalent entities.

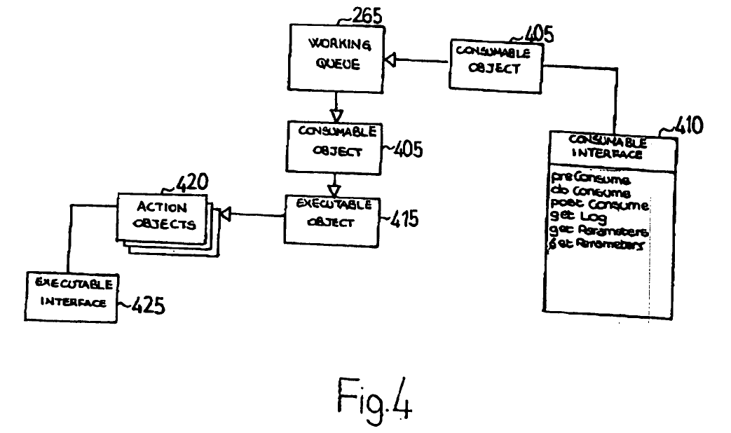

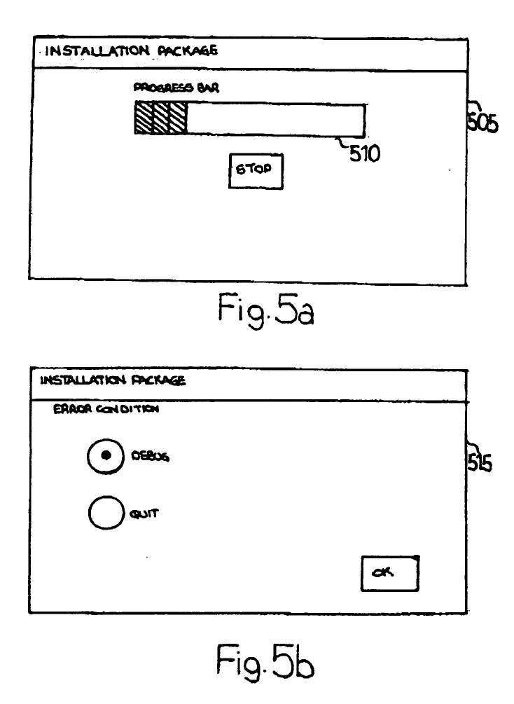

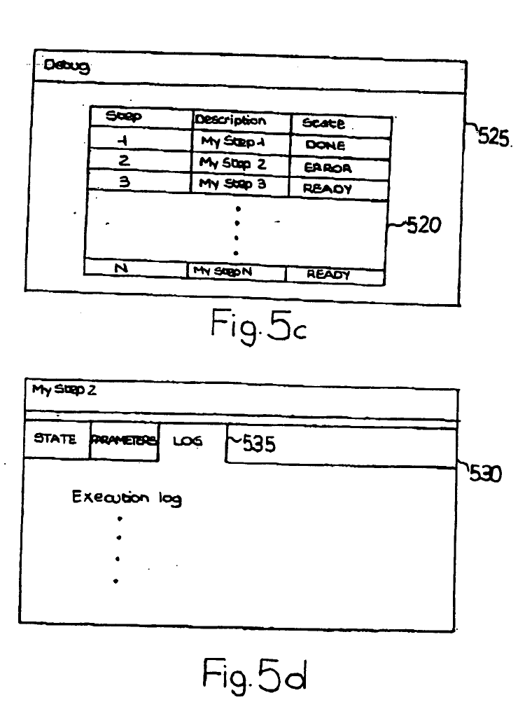

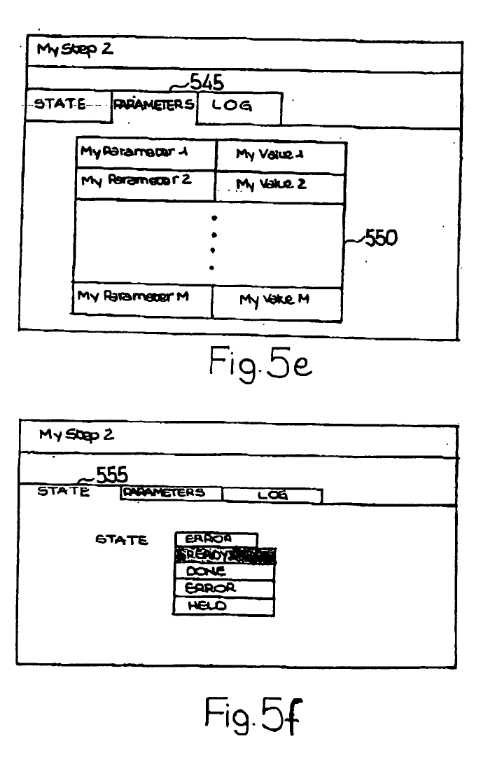

An exemplary scenario involved by the application of an installation package according to the present invention is illustrated in the panels of FIGS. 5a-5f. Considering in particular FIG. 5a, once the working queue has been completed the consumer starts processing the corresponding consumable objects in sequence. As usual, a panel 505 with a progress bar 510 is displayed to the administrator. If an error is detected in response to the methods preConsume, doConsume or postConsume (assuming that the consumer has been configured to stop the installation operation), the debugger is invoked. Therefore, as shown in FIG. 5b, a panel 515 is provided for allowing the administrator to debug the installation package or to quit the process. Passing now to FIG. 5c, if the administrator chooses the debug option a list 520 of all the consumable objects in the working queue (together with their descriptions and state flags) is displayed in a panel 525. In the example at issue, the consumable object MyStep1 has been executed successfully (state flag=DONE), while the consumable object MyStep2 has been aborted (state flag=ERROR); all the next consumable objects MyStep3-MyStepN are still to be executed (state flag=READY).

Whenever a consumable object is selected (for example, the consumable object MyStep2 with the state flag at the value ERROR), a corresponding tabbed pane 530 is displayed (see FIG. 5d). Assuming that the administrator has clicked on a selection tab 535 for the execution log, a corresponding panel with the desired information is popped up. Passing to FIG. 5e, the administrator can now click on a selection tab 545 for the operative parameters; in this case, an editable list 550 with all the operative parameters associated with the installation operation is provided; in this way, the administrator is allowed to fix the problem updating any wrong operative parameter (for example, a server name). The administrator then clicks on a selection tab 555 for the state flag (see FIG. 5f), and changes the state flag of the installation operation from the value ERROR to the value READY. The installation process can now be resumed, with the re-execution of any pending installation operations (including the one previously in error).

Similar considerations apply to different scenarios; in any case, the devised solution leads itself to be implemented even with an equivalent user interface (for example, involving the display of different panels).

More generally, an aspect of the present invention proposes a software installation method. The method uses a wizard-based installation package for enforcing desired software features on a data processing system according to a set of operative parameters. The method starts with the step of installing the package on the system. The installation is suspended in response to an error condition, which relates to one or more operative parameters of the set. The method continues updating the above-mentioned operative parameters. The installation is then resumed.

The solution of the invention provides a wizard-based installation package, which allows interacting with the enforcement of the desired software features.

Particularly, the method of the invention makes it possible to interact dynamically with the installation package whenever an error condition occurs.

The devised solution strongly facilitates the debugging to the installation package.

In addition, the method of the invention avoids repeating the whole installation process once the error has been fixed.

Particularly, the proposed solution allows correcting wrong operative parameters dynamically.

These advantages are clearly perceived when dealing with the installation of complex software applications, especially in data processing systems with a distributed architecture (even if different applications are not excluded).

The preferred embodiment of the invention described above offers further advantages.

Particularly, the installation of the package involves the creation of the working queue dynamically (with the corresponding installation operations that are then executed in succession).

This approach strongly simplifies the management of the suspension/resumption of the installation process. For example, the working queue avoids any problem with branches (being the corresponding choices already taken during its creation).

A suggested choice for implementing the installation package is that of embedding the discoverer, the descriptor and the producer.

The proposed structure provides a dynamic behavior of the installation package (being the installation operations determined at run-time); this is particularly advantageous in complex environments, wherein no assumptions can be made (when the installation package is built) about the structure of the data processing system on which the software application will be installed.

As a further improvement, the installation operations in the working queue are executed under the control of the consumer.

This approach simplifies the definition and the maintenance of the installation package; moreover, the use of the consumer results in a modular structure of the installation package.

However, the present invention leads itself to be practiced defining the installation operations in a different way (even without any working queue), or embedding alternative installation elements into the installation package (for example, exploiting the product tree and the wizard tree as usual).

Preferably, each state flag is set to the value DONE once the corresponding installation operation has been successfully executed (so as to skip its execution afterwards).

This feature facilitates the management of the installation operations whenever the installation process is resumed.

As a further enhancement, the state flag of any installation operation dependent on a failed one is set to the value HELD (so as to skip its execution).

The proposed solution allows continuing the installation process even in case of an error.

Advantageously, the state flag can be changed from the value HELD to the value READY to enable the execution of the corresponding installation operation.

This option helps the administrator debug the installation package (for example, performing the installation process step-by-step).

A suggested choice for implementing the management of the state flags consists of setting them according of the result of the pre-execution verification of the corresponding installation operations.

Therefore, error conditions are readily identified without the need of actually executing the installation operations.

A way to further improve the solution is that of saving the execution log of each installation operation.

This feature avoids loosing valuable information (which could be overwritten by the execution of the next installation operations); moreover, the different execution logs strongly simplify the debugging of the installation package.

In any case, the solution of the invention is also suitable to be implemented without any state flag and controlling the working queue with a different algorithm (for example, using a pointer to the first installation operation to be executed) Alternatively, the installation package is configured only for forcing the installation process to continue or for stopping the same in response to an error condition, or the state flags are reset to the value READY automatically (for example, when a corresponding operative parameter is updated or the state flag associated with any pre-requisite installation operation is changed to the value READY). Moreover, the state flags can be set only according to the result of the actual execution of the corresponding installation operations, or a single execution log of the whole installation process can be envisaged.

Advantageously, the solution according to the present invention is implemented with a computer program, which is provided as a corresponding product embodied in a suitable medium.

Alternatively, the program is pre-loaded onto the hard-disk, is sent to the administration computer through a network (typically the INTERNET), is broadcast, or more generally is provided in any other form directly loadable into the working memory of the administration computer. However, the method according to the present invention leads itself to be carried out with a hardware structure (for example, integrated in a chip of semiconductor material), or with a combination of software and hardware.

Naturally, in order to satisfy local and specific requirements, a person skilled in the art may apply to the solution described above many modifications and alterations all of which, however, are included within the scope of protection of the invention as defined by the following claims.

1. A software installation method using a wizard-based installation package for enforcing desired software features on a data processing system according to a set of operative parameters, the method including the steps of:
installing the package on the system,
suspending the installation in response to an error condition relating to at least one operative parameter of the set,
updating the at least one operative parameter, and
resuming the installation.

2. The method according to claim 1, wherein the step of installing the package includes:
creating a working queue dynamically, the working queue specifying a sequence of installation operations to be executed on the system for enforcing the desired software features, and
executing the installation operations in succession.

3. The method according to claim 2, wherein the package embeds installation elements being previously declared during a building of the package, the step of creating the working queue including:
a discoverer installation element detecting a current configuration of the system, and
a producer installation element inserting an indication of consumable objects into the working queue, the consumable objects implementing the installation operations required for reaching a target configuring defined in a descriptor installation element from the current configuration.

4. The method according to claim 3, wherein the step of executing the installation operations in succession includes:
a consumer installation element calling an execution method exposed by each consumable object for causing the execution of the corresponding installation operations.

5. The method according to claim 2, further including the steps of:
associating a state indicator having a ready value to each installation operation to be executed,
setting the state indicator associated with each executed installation operation to a done value in response to a successful result of the execution or to an error value in response to an unsuccessful result of the execution, and
skipping the execution of each installation operation having the corresponding state indicator at the done value.

6. The method according to claim 5, further including the steps of:
setting the state indicator associated with each installation operation dependent from an installation operation having the corresponding state indicator at the error value to a held value, and
skipping the execution of each installation operation having the corresponding state indicator at the held value.

7. The method according to claim 6, further including the steps of:
selecting an installation operation having the corresponding state indicator at the held value,
updating the state indicator associated with the selected installation operation to the ready value, and
executing the selected installation operation.

8. The method according to claim 2, further including the steps of:
verifying whether each installation operation is executable, and
setting the corresponding state indicator to the error value in response to a negative result of the verification.

9. The method according to claim 2, further including the steps of:
saving an execution log for each executed installation operation,
selecting a further installation operation, and
displaying the execution log of the further selected installation operation.

10. A computer program directly loadable into a working memory of a data processing system, for performing the method of claim 1 when the program is run on the system.

11. A program product comprising a computer readable medium embodying the program of claim 10.

12. A software installation structure using a wizard-based installation package for enforcing desired software features on a data processing system according to a set of operative parameters, the structure including means for installing the package on the system, means for suspending the installation in response to an error condition relating to at least one operative parameter of the set, means for updating the at least one operative parameter, and means for resuming the installation.
